(19) United States
(12) Patent Application Publication
(10) Pub. No.: US 2017/0308941 A1
(43) Pub. Date: Oct. 26, 2017

(54) DETECTION OF POTENTIAL GREY MARKET ACTIVITIES

(71) Applicant: HEWLETT PACKARD ENTERPRISE DEVELOPMENT LP, Houston, TX (US)

(72) Inventors: Alexander HIPOLITO, Singapore (SG); Paul ABRAHAM, Bangalore (IN); Lynda K. JARRETT, Houston, TX (US); Saumyendra MATHUR, Houston, TX (US); Alaxandra SCHMIDT, Singapore (SG)

(73) Assignee: HEWLETT PACKARD ENTERPRISE DEVELOPMENT LP, Houston, TX (US)

(21) Appl. No.: 15/510,195

(22) PCT Filed: Oct. 29, 2014
(86) PCT No.: PCT/US2014/062860

§ 371 Date: Mar. 9, 2017

(51) Int. Cl. G06Q 30/06; G06F 17/30

(52) U.S. Cl. CPC G06Q 30/0609; G06F 17/30241

(57) ABSTRACT

Examples relate to detecting potential grey market activities. The examples disclosed herein enable storing, in a product database, a plurality of product identifiers. At least one of the plurality of product identifiers may be associated with a promotion that is intended for at least one end customer. The examples disclosed herein enable triggering a detection of a potential grey market activity in response to receiving customer registration information from a first end customer. The customer registration information may comprise a first product identifier. The detection of the potential grey market activity comprises identifying the first product identifier in the product database and the promotion associated with the first product identifier, and determining whether the first end customer is the end customer for which the promotion associated with the first product identifier is intended.

### BACKGROUND

The grey market refers to the trade of products through a distribution channel that is unauthorized, unofficial, or unintended by an original manufacturer. A typical grey market activity occurs when products are sold outside of an authorized distribution channel. Grey marketing has many negative impacts on the manufacturer or the distributors of the products, including reduced revenues, margin erosion, negative reputation, service and warranty problems, and reduced customer satisfaction.

### BRIEF DESCRIPTION OF THE DRAWINGS

The following detailed description references the drawings, wherein:

FIG. 1 is a block diagram depicting an example environment in which various examples may be implemented as a grey market detecting system.

FIG. 2 is a block diagram depicting an example grey market detecting system.

FIG. 3 is a block diagram depicting an example machine-readable storage medium comprising instructions executable by a processor for detecting potential grey market activities.

FIG. 4 is a block diagram depicting an example machine-readable storage medium comprising instructions executable by a processor for detecting potential grey market activities.

FIG. 5 is a flow diagram depicting an example method for detecting potential grey market activities.

FIG. 6 is a flow diagram depicting an example method for detecting potential grey market activities.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The grey market refers to the trade of products through a distribution channel that is unauthorized, unofficial, or unintended by an original manufacturer. A typical grey market activity occurs when products are sold outside of an authorized distribution channel. Grey marketing has many negative impacts on the manufacturer or the distributors of the products, including reduced revenues, margin erosion, negative reputation, service and warranty problems, and reduced customer satisfaction. Sales through grey market channels usually go undetected because there is no easy way to monitor potential grey market activities and promptly alert the affected parties upon detection of a potential grey market activity.

Examples disclosed herein enable automatically triggering a detection of a potential grey market activity in response to receiving customer registration information from an end customer of a product, detecting the potential grey market activity based on the customer registration information and promotion information related to the product, and/or generating a notification upon detection of the potential grey market activity.

A “grey market activity,” as used herein, may refer to an occurrence of a product being diverted from its authorized distribution path, chain, or channel. The grey market activity may include, for example, a sale of a product outside of its authorized distribution chain or an unauthorized importation of a product into another country.

A “product,” as used herein, may refer to a service or an item offered for sale and/or distribution. The product may include tangible goods or intangible goods such as software and digital products.

A “promotion,” as used herein, may refer to a deal, a discount, a rebate, a coupon, and/or an advertisement related to a particular product or a group of products.

A “customer,” as used herein, may carry a broad meaning, depending on the point in the distribution chain through which a product is distributed. A customer who makes a final purchase of the product and/or receives the product at the end point of the distribution chain may be referred herein as an “end customer.” The end customer is usually an individual, corporate or governmental “end customer.” A customer may include a wholesaler, broker, institutional buyer, government and private manufacturer, consolidator, and/or re-packager who purchases and/or receives the product before the product reaches the end customer.

“Customer registration information,” as used herein, may refer to information an end customer provides about a product that the end customer purchased or received at the end point of the distribution chain. The end customer may provide the customer registration information by submitting a product registration, submitting a product survey, purchasing a warranty, making a warranty claim, activating licenses associated with the product, and/or other suitable ways. The customer registration information may include, but not limited to, a product identifier, a name of the end customer, an organization that the end customer belongs to (e.g., a team, an office, a company, a government, and/or other organization types), and/or a geographical location associated with the end customer (e.g., where the end customer purchased the product from and/or received the product, country, city, zip code, home address, mailing address, work address, etc.).

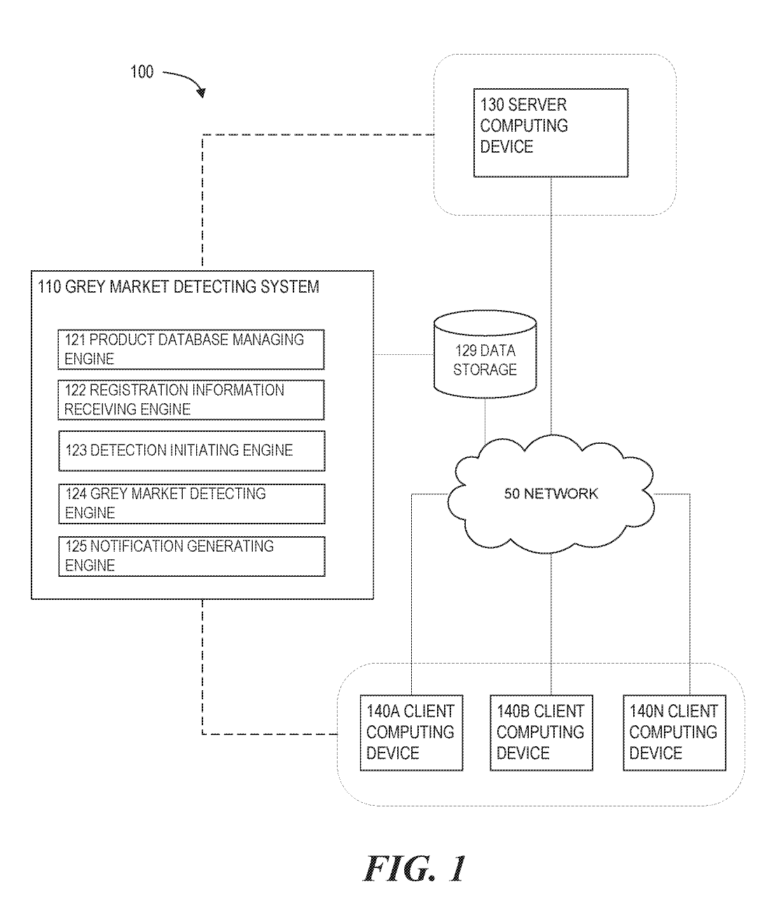

FIG. 1 is an example environment 100 in which various examples may be implemented as a grey market detecting system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, grey market detecting system 110 and the various components described herein may be implemented in hardware and/or a combination of hardware and programming that configures hardware. Furthermore, in FIG. 1 and other figures described herein, different numbers of components or entities than depicted may be used.

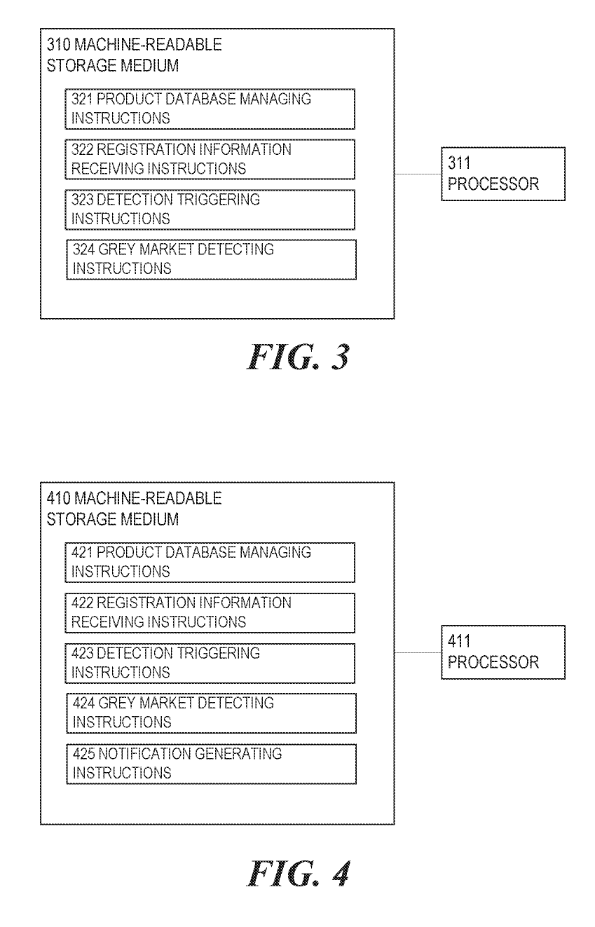

Grey market detecting system 110 may comprise a product database managing engine 121, a registration information receiving engine 122, a detection initiating engine 123, a grey market detecting engine 124, a notification generating engine 125, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Product database managing engine 121 may manage and/or store, in a product database (e.g., a data storage 129), information related to a product, including a product identifier (e.g., a serial number, a universal product identifier code (UPC), and/or other identifying information that uniquely identifies individual products), a product description, a shipping destination of the product (e.g., country, city, zip code, mailing address, etc.), and/or other information related to the product. At least one product identifier may be associated with a promotion (e.g., a promotion identifier). A “promotion,” as used herein, may refer to a deal, a discount, a rebate, a coupon, and/or an advertisement related to a particular product or a group of products. The promotion may be associated with at least one end customer that the promotion is intended for. As discussed above, an “end customer” may refer to a customer who makes a final purchase of the product and/or receives the product at the end point of the distribution chain.

The end customer(s) associated with the promotion may represent a target audience for the particular promotion. Information related to the end customer may include a name of the end customer, an organization that the end customer belongs to (e.g., a team, an office, a company, a government, and/or other organization types), and/or a geographical location associated with the end customer (e.g., country, city, zip code, home address, mailing address, work address, etc.), and/or other information relevant to the end customer.

The product information, the promotion information and/or the end customer information, as discussed above, may be collected from a plurality of different sources. Note that the product information, the promotion information, and/or the end customer information may be stored in the product database (e.g., data storage 129) that may represent a single database or multiple databases.

Registration information receiving engine 122 may receive customer registration information from a first end customer. “Customer registration information,” as used herein, may refer to information an end customer provides about a product that the end customer purchased or received at the end point of the distribution chain. The end customer may provide the customer registration information by submitting a product registration, submitting a product survey, purchasing a warranty, making a warranty claim, activating licenses associated with the product, and/or other suitable ways. For example, when the user purchases the product, there is a strong incentive to register the purchased product. In the event of a recall or safety notice, the end customer may be contacted immediately. In the event of a loss due to fire, flood, or theft, the registration may serve as proof of purchase for the insurance carrier. The registration may activate a warranty on the product.

The customer registration information may include, but not limited to, a first product identifier (e.g., uniquely identifying the product), a name of the first end customer, an organization that the first end customer belongs to (e.g., a team, an office, a company, a government, and/or other organization types), and/or a geographical location associated with the first end customer (e.g., where the end customer purchased the product from and/or received the product, country, city, zip code, home address, mailing address, work address, etc.).

In response to receiving the customer registration information, detection initiating engine 123 may initiate a detection of a potential grey market activity. The detection may be automatically triggered without human intervention upon the receipt of the customer registration information. For example, when the first end customer submits a product registration via the manufacturer's or distributor's website, the detection may be automatically initiated upon the submission of the registration.

Grey market detecting engine 124 may detect a potential grey market activity based on the received customer registration information and the information stored in the product database. Grey market detecting engine 124 may retrieve the first product identifier from the customer registration information and access the product database to identify the first product identifier in the product database. Once grey market detecting engine 124 finds a product identifier that may match the first product identifier, grey market detecting engine 124 may identify the shipping destination and the promotion associated with the first product identifier in the product database.

In some implementations, grey market detecting engine 124 may determine whether the shipping destination (from the product database) is the geographical location of the first end customer (from the customer registration information). For example, grey market detecting engine 124 may compare the zip code specified in the shipping destination to the zip code specified in the customer registration information. In another example, grey market detecting engine 124 may determine whether the zip code specified in the customer registration information is within the country specified in the shipping destination.

In some implementations, grey market detecting engine 124 may determine whether the first end customer (from which the customer registration information is received) is the end customer for which the promotion associated with the first product identifier is intended. In doing so, grey market detecting engine 124 may compare the end customer information found in the promotion (associated with the first product identifier) to the first end customer information found in the customer registration information. For example, the name, organization, and/or geographical location of the end customer information of the promotion may be compared with the name, organization, and/or geographical location of the first end customer information found in the customer registration information.

In some implementations, grey market detecting engine 124 may determine whether the geographical location of the first end customer found in the customer registration information belongs to a predefined list of geographical locations. The predefined list of geographical locations may include, for example, a list of locations authorized by an original manufacturer. In this example, if the customer registration information indicates that the first end customer is associated with a particular location that is within at least one location of the list of locations, it may be more likely that the product did not end up in the grey market. On the other hand, if the predefined list of geographical locations refers to a list of unauthorized locations, it may be more likely that a potential grey market activity is detected.

Grey market detecting engine 124 may determine whether the potential grey market activity exists based on at least one of the determinations and/or comparisons discussed above with respect to grey market detecting engine 124. For example, in response to determining that the first end customer (from which the customer registration information is received) is not the end customer for which the promotion is intended, it may be determined that the potential grey market activity is detected.

Notification generating engine 125 may generate a notification (e.g., an alert, a report, etc.) that the potential grey market activity is detected. The notification may include a reason for the detection. Going back to the example above, the reason may be that the first end customer (from which the customer registration information has been received) is not the end customer for which the promotion is intended. In this way, a user of grey market detecting system 110 (e.g., the manufacturer and/or the distributor of the product) may be automatically notified of the potential grey market activity, allowing the user to conduct further research on the potential grey market activity with respect to the product at issue.

In performing their respective functions, engines 121-125 may access data storage 129. Data storage 129 may represent any memory accessible to grey market detecting system 110 that can be used to store and retrieve data. Data storage 129 may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Grey market detecting system 110 may access data storage 129 locally or remotely via network 50 or other networks.

Data storage 129 may include a database to organize and store data. Database 129 may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may reside in a single or multiple physical device(s) and in a single or multiple physical location(s). The database may store a plurality of types of data and/or files and associated data or file description, administrative information, or any other data.

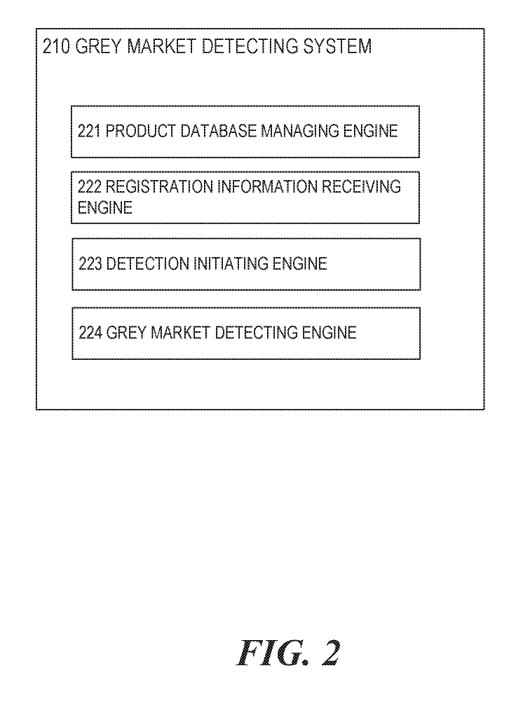

FIG. 2 is a block diagram depicting an example grey market detecting system 210. Grey market detecting system 210 may comprise a product database managing engine 221, a registration information receiving engine 222, a detecting initiating engine 223, a grey market detecting engine 224, and/or other engines. Engines 221-224 represent engines 121, 122, 123, and 124, respectively.

FIG. 3 is a block diagram depicting an example machine-readable storage medium 310 comprising instructions executable by a processor for detecting potential grey market activities.

In the foregoing discussion, engines 121-125 were described as combinations of hardware and programming. Engines 121-125 may be implemented in a number of fashions. Referring to FIG. 3, the programming may be processor executable instructions 321-324 stored on a machine-readable storage medium 310 and the hardware may include a processor 311 for executing those instructions. Thus, machine-readable storage medium 310 can be said to store program instructions or code that when executed by processor 311 implements grey market detecting system 110 of FIG. 1.

In FIG. 3, the executable program instructions in machine-readable storage medium 310 are depicted as product database managing instructions 321, registration information receiving instructions 322, detection triggering instructions 323, and grey market detecting instructions 324. Instructions 321-324 represent program instructions that, when executed, cause processor 311 to implement engines 121-124, respectively.

FIG. 4 is a block diagram depicting an example machine-readable storage medium 410 comprising instructions executable by a processor for detecting potential grey market activities.

In the foregoing discussion, engines 121-125 were described as combinations of hardware and programming. Engines 121-125 may be implemented in a number of fashions. Referring to FIG. 4, the programming may be processor executable instructions 421-425 stored on a machine-readable storage medium 410 and the hardware may include a processor 411 for executing those instructions. Thus, machine-readable storage medium 410 can be said to store program instructions or code that when executed by processor 411 implements grey market detecting system 110 of FIG. 1.

In FIG. 4, the executable program instructions in machine-readable storage medium 410 are depicted as product database managing instructions 421, registration information receiving instructions 422, detection triggering instructions 423, grey market detecting instructions 424, and notification generating instructions 425. Instructions 421-425 represent program instructions that, when executed, cause processor 411 to implement engines 121-125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement grey market detecting system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-324, and/or other instructions. As an alternative or in addition to retrieving and executing instructions, processor 311 may include at least one electronic circuit comprising a number of electronic components for performing the functionality of at least one of instructions 321-324, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-425, and/or other instructions. As an alternative or in addition to retrieving and executing instructions, processor 411 may include at least one electronic circuit comprising a number of electronic components for performing the functionality of at least one of instructions 421-425, and/or other instructions.

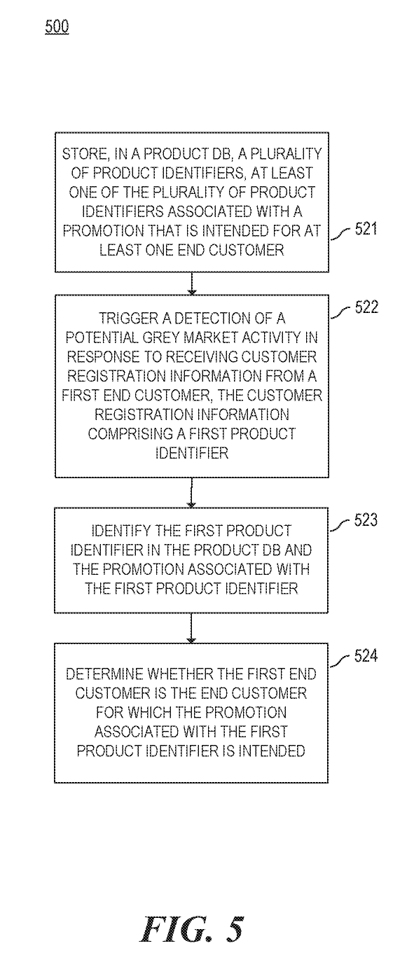

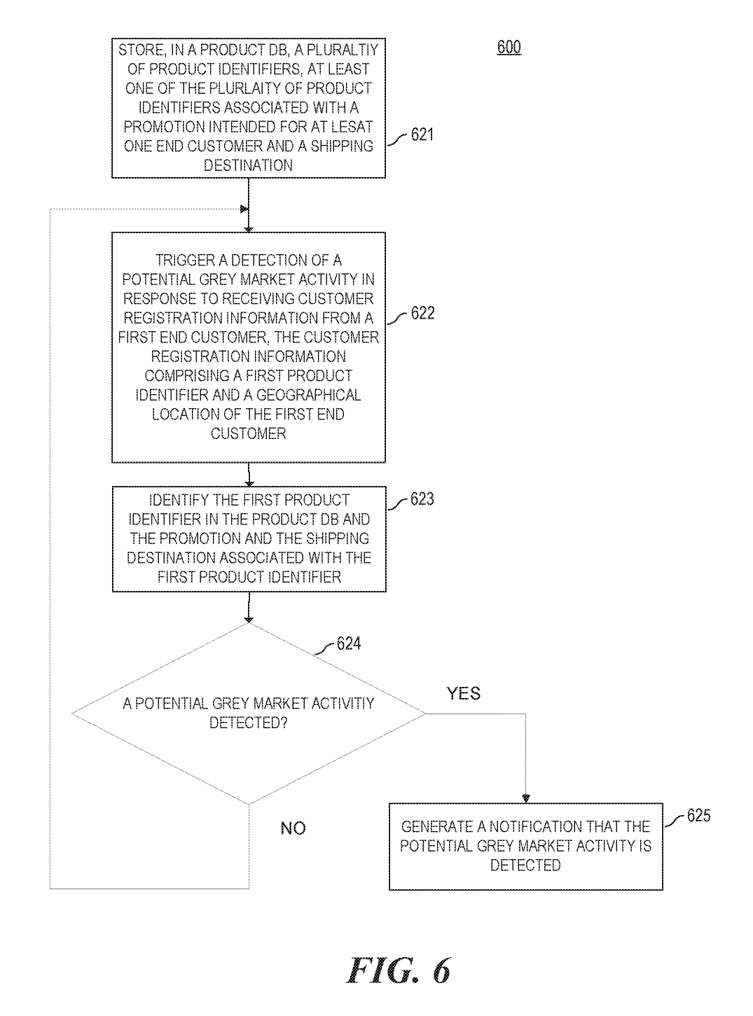

FIG. 5 is a flow diagram depicting an example method 500 for detecting potential grey market activities. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

Method 500 may start in block 521 where a plurality of product identifiers may be stored in a product database (e.g., data storage 129 of FIG. 1). A product identifier may be a serial number, a universal product identifier code (UPC), and/or other identifying information uniquely identifies individual products. A product identifier may be associated with a product description, a shipping destination of the product (e.g., country, city, zip code, mailing address, etc.), and/or other information related to the product. At least one product identifier may be associated with a promotion (e.g., a promotion identifier) that is intended for at least one end customer. The end customer(s) associated with the promotion may represent a target audience for the particular promotion. Information related to the end customer may include a name of the end customer, an organization that the end customer belongs to (e.g., a team, an office, a company, a government, and/or other organization types), and/or a geographical location associated with the end customer (e.g., country, city, zip code, home address, mailing address, work address, etc.), and/or other information relevant to the end customer.

In block 522, method 500 may include triggering a detection of a potential grey market activity in response to receiving customer registration information from a first end customer. The first end customer may provide the customer registration information by submitting a product registration, submitting a product survey, purchasing a warranty, making a warranty claim, activating licenses associated with the product, and/or other suitable ways. The customer registration information may include, but not be limited to, a first product identifier (e.g., uniquely identifying the product), a name of the first end customer, an organization that the first end customer belongs to (e.g., a team, an office, a company, a government, and/or other organization types), and/or a geographical location associated with the first end customer (e.g., where the end customer purchased the product from and/or received the product, country, city, zip code, home address, mailing address, work address, etc.).

The detection may be automatically triggered without human intervention upon the receipt of the customer registration information. For example, when the first end customer submits a product registration via the manufacturer's or distributor's website, the detection may be automatically triggered upon the submission of the registration.

In block 523, method 500 may include identifying the first product identifier in the product database. For example, the first product identifier may be retrieved from the customer registration information. The product database may be accessed to identify the first product identifier in the product database. Once a product identifier that may match the first product identifier is found in the product database, method 500 may identify the promotion associated with the first product identifier in the product database.

In block 524, method 500 may include determining whether the first end customer is the end customer for which the promotion associated with the first product identifier is intended. Based on the determination, it may be determined whether the potential grey market activity exists. For example, in response to determining that the first end customer (from which the customer registration information is received) is not the end customer for which the promotion is intended, it may be determined that the potential grey market activity is detected.

Referring back to FIG. 1, product database managing engine 121 may be responsible for implementing block 521. Detection initiating engine 123 may be responsible for implementing block 522. Grey market detecting engine 124 may be responsible for implementing blocks 523-524.

FIG. 6 is a flow diagram depicting an example method 600 for detecting potential grey market activities. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where a plurality of product identifiers may be stored in a product database (e.g., data storage 129 of FIG. 1). A product identifier may be a serial number, a universal product identifier code (UPC), and/or other identifying information uniquely identifies individual products. A product identifier may be associated with a product description, a shipping destination of the product (e.g., country, city, zip code, mailing address, etc.), and/or other information related to the product. At least one product identifier may be associated with a promotion (e.g., a promotion identifier) that is intended for at least one end customer. The end customer(s) associated with the promotion may represent a target audience for the particular promotion. Information related to the end customer may include a name of the end customer, an organization that the end customer belongs to (e.g., a team, an office, a company, a government, and/or other organization types), and/or a geographical location associated with the end customer (e.g., country, city, zip code, home address, mailing address, work address, etc.), and/or other information relevant to the end customer.

In block 622, method 600 may include triggering a detection of a potential grey market activity in response to receiving customer registration information from a first end customer. The first end customer may provide the customer registration information by submitting a product registration, submitting a product survey, purchasing a warranty, making a warranty claim, activating licenses associated with the product, and/or other suitable ways. The customer registration information may include, but not limited to, a first product identifier (e.g., uniquely identifying the product), a name of the first end customer, an organization that the first end customer belongs to (e.g., a team, an office, a company, a government, and/or other organization types), and/or a geographical location associated with the first end customer (e.g., where the end customer purchased the product from and/or received the product, country, city, zip code, home address, mailing address, work address, etc.).

The detection may be automatically triggered without human intervention upon the receipt of the customer registration information. For example, when the first end customer submits a product registration via the manufacturer's or distributor's website, the detection may be automatically triggered upon the submission of the registration.

In block 623, method 600 may include identifying the first product identifier in the product database. For example, the first product identifier may be retrieved from the customer registration information. The product database may be accessed to identify the first product identifier in the product database. Once a product identifier that may match the first product identifier is found in the product database, method 600 may identify the shipping destination and the promotion associated with the first product identifier in the product database.

In block 624, method 600 may include determining whether a potential grey market activity is detected based on the received customer registration information and the information stored in the product database.

In some implementations, method 600 may determine whether the shipping destination (from the product database) is the geographical location of the first end customer (from the customer registration information). For example, the zip code specified in the shipping destination may be compared to the zip code specified in the customer registration information. In some implementations, method 600 may determine whether the first end customer (from which the customer registration information is received) is the end customer for which the promotion associated with the first product identifier is intended. In doing so, the end customer information found in the promotion (associated with the first product identifier) may be compared to the first end customer information found in the customer registration information. For example, the name, organization, and/or geographical location of the end customer information of the promotion may be compared with the name, organization, and/or geographical location of the first end customer information found in the customer registration information.

In some implementations, method 600 may determine whether the geographical location of the first end customer found in the customer registration information belongs to a predefined list of geographical locations. The predefined list of geographical locations may include, for example, a list of locations authorized by an original manufacturer. In this example, if the customer registration information indicates that the first end customer is associated with a particular location that is within at least one location of the list of locations, it may be more likely that the product did not end up in the grey market. On the other hand, if the predefined list of geographical locations refers to a list of unauthorized locations, it may be more likely that a potential grey market activity is detected.

Method 600 may determine whether the potential grey market activity exists based on at least one of the determinations and/or comparisons discussed above with respect to block 624. If method 600 determines in block 624 that no potential grey market activity is detected, method 600 may return to block 622.

On the other hand, if method 600 determines in block 624 that the potential grey market activity has been detected, method 600 may proceed to block 625. For example, in response to determining that the first end customer (from which the customer registration information is received) is not the end customer for which the promotion is intended, it may be determined that the potential grey market activity is detected.

In block 625, method 600 may include generating a notification (e.g., an alert, a report, etc.) that the potential grey market activity is detected. The notification may include a reason for the detection. Going back to the example above, the reason may be that the first end customer (from which the customer registration information has been received) is not the end customer for which the promotion is intended. In this way, a user (e.g., the manufacturer and/or the distributor of the product) may be automatically notified of the potential grey market activity, allowing the user to conduct further research on the potential grey market activity with respect to the product at issue.

Referring back to FIG. 1, product database managing engine 121 may be responsible for implementing block 621. Detection initiating engine 123 may be responsible for implementing block 622. Grey market detecting engine 124 may be responsible for implementing blocks 623-624. Notification generating engine 125 may be responsible for implementing block 625.

The foregoing disclosure describes a number of example implementations for detection of potential grey market activities. The disclosed examples may include systems, devices, computer-readable storage media, and methods for detection of potential grey market activities. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequences of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a computing device for detecting potential grey market activities, the method comprising:
storing, in a product database, a plurality of product identifiers, at least one of the plurality of product identifiers associated with a promotion that is intended for at least one end customer; and
triggering a detection of a potential grey market activity in response to receiving customer registration information from a first end customer, the customer registration information comprising a first product identifier, wherein the detection of the potential grey market activity comprises:
identifying the first product identifier in the product database and the promotion associated with the first product identifier, and
determining whether the first end customer is the end customer for which the promotion associated with the first product identifier is intended.

2. The method of claim 1, wherein the first end customer provides the customer registration information by at least one of submitting a product registration, submitting a product survey, purchasing a warranty, making a warranty claim, and activating licenses associated with the product identified by the first product identifier.

3. The method of claim 1, further comprising:
in response to determining that the first end customer is not the end customer for which the promotion associated with the first product identifier is intended, determining that the potential grey market activity is detected.

4. The method of claim 3, further comprising:
generating a notification that the potential grey market activity is detected, wherein the notification indicates that the first end customer is not the end customer for which the promotion associated with the first product identifier is intended.

5. The method of claim 1, wherein at least one of the plurality of product identifiers is associated with a shipping destination to which a product identified by the at least one of the plurality of product identifiers is shipped, further comprising:
determining a geographical location where the first end customer is located based on the customer registration information, and
wherein the detection of the potential grey market activity further comprises:
determining whether the geographical location of the first end customer is the shipping destination associated with the first product identifier.

6. A non-transitory machine-readable storage medium comprising instructions executable by a processor of a computing device for detecting potential grey market activities, the non-transitory machine-readable storage medium comprising:
instructions to store, in a product database, a plurality of product identifiers, at least one of the plurality of product identifiers associated with a promotion that is associated with information related to an end customer, wherein the information related to the end customer comprises at least one of a name of the end customer, an organization that the end customer belongs to, and a geographical location where the end customer is located;
instructions to receive customer registration information from a first end customer, the customer registration information comprising a first product identifier and a first end customer identifier that indicates at least one of a name of the first end customer, an organization that the first end customer belongs to, and a geographical location where the first end customer is located; and
in response to receiving the customer registration information, instructions to cause a detection of a potential grey market activity to be triggered, wherein the detection of the potential grey market activity comprises:
identifying the first product identifier in the product database and the promotion associated with the first product identifier,
verifying the first end customer identifier against the information related to the end customer of the promotion associated with the first product identifier, and
determining whether the potential grey market activity exists based on the verification.

7. The non-transitory machine-readable storage medium of claim 6, wherein verifying the first end customer identifier against the information related to the end customer of the promotion associated with the first product identifier comprises at least one of:
comparing the name of the end customer of the promotion associated with the first product identifier to the name of the first end customer,
comparing the organization of the end customer of the promotion associated with the first product identifier to the organization of the first end customer, and
comparing the geographical location of the end customer of the promotion associated with the first product identifier to the geographical location of the first end customer.

8. The non-transitory machine-readable storage medium of claim 6, wherein the first end customer provides the customer registration information by at least one of submitting a product registration, submitting a product survey, purchasing a warranty, making a warranty claim, and activating licenses associated with the product identified by the first product identifier.

9. The non-transitory machine-readable storage medium of claim 6, further comprising:
in response to determining that the potential grey market activity exists based on the verification, instructions to generate a notification that indicates that the first end customer is not the end customer of the promotion associated with the first product identifier.

10. The non-transitory machine-readable storage medium of claim 6, wherein at least one of the plurality of product identifiers is associated with a shipping destination to which a product identified by the at least one of the plurality of product identifiers is shipped, and wherein the detection of the potential grey market activity further comprises:
verifying the geographical location of the first end customer against the shipping destination associated with the first product identifier.

11. A system for detecting potential grey market activities comprising:
a product database that:
stores a plurality of product identifiers, at least one of the plurality of identifiers associated with a shipping destination and a promotion that is intended for at least one end customer; and
a processor that:
receives customer registration information from a first end customer, the customer registration information comprising a first product identifier of a product purchased by the first end customer and a geographical location of the first end customer; and
initiates, in response to receiving the customer registration information, a detection of a potential grey market activity, wherein the detection of the potential grey market activity comprises:
identifying the first product identifier in the product database and the shipping destination and the promotion associated with the first product identifier,
determining whether the geographical location of the first end customer is the shipping destination associated with the first product identifier, and
determining whether the first end customer is the end customer for which the promotion associated with the first product identifier is intended.

12. The system of claim 11, wherein the detection of the potential grey market activity further comprises:
in response to determining that the first end customer is not the end customer for which the promotion associated with the first product identifier is intended, determining that the potential grey market activity is detected.

13. The system of claim 12, further comprising:
generating a notification that the potential grey market activity is detected, wherein the notification indicates that the first end customer is not the end customer for which the promotion associated with the first product identifier is intended.

14. The system of claim 11, wherein the first end customer provides the customer registration information by at least one of submitting a product registration, submitting a product survey, purchasing a warranty, making a warranty claim, and activating licenses associated with the product identified by the first product identifier.

15. The system of claim 11, wherein the detection of the potential grey market activity further comprises:
determining whether the geographical location of the first end customer belongs to a predefined list of geographical locations.
